(19) United States
(12) Patent Application Publication
(10) Pub. No.: US 2016/0016401 A1
(43) Pub. Date: Jan. 21, 2016

(54) INKJET HEAD AND INKJET PRINTER

(71) Applicants: KABUSHIKI KAISHA TOSHIBA, Tokyo (JP); TOSHIBA TEC KABUSHIKI KAISHA, Tokyo (JP)

(72) Inventors: Teruyuki Hiyoshi, Shizuoka (JP); Noboru Nitta, Shizuoka (JP); Shunichi Ono, Shizuoka (JP)

(21) Appl. No.: 14/802,166

(22) Filed: Jul. 17, 2015

(30) Foreign Application Priority Data
Jul. 17, 2014 (JP) 2014-147148

(51) Int. Cl. B41J 2/045

(52) U.S. Cl. CPC B41J 2/04541; B41J 2/04586

(57) ABSTRACT

According to one embodiment, an inkjet head includes: a pressure chamber which is filled with an ink; a plate having nozzles communicating with the pressure chamber; an actuator that causes ink drops to be discharged from the nozzles communicating with the pressure chamber by changing a volume in the pressure chamber; and a drive circuit that outputs a drive pulse signal including an expansion pulse which expands the volume of the pressure chamber and a shrinking pulse which shrinks the volume of the pressure chamber to the actuator such that the drive pulse signal is output, in which an electric field applied to the actuator during the time for not discharging the ink drops is lower than an electric field applied to the actuator during the time for discharging the ink drops.

### CROSS-REFERENCE TO RELATED APPLICATION

This application is based upon and claims the benefit of priority from Japanese Patent Application No. 2014-147148, filed Jul. 17, 2014, the entire contents of which are incorporated herein by reference.

### FIELD

Embodiments described herein relate generally to an inkjet head and an inkjet printer using the head.

### BACKGROUND

An inkjet head includes a pressure chamber which is filled with an ink, an actuator provided on the pressure chamber, and nozzles communicating with the pressure chamber. In the inkjet head, when a drive pulse signal is applied to the actuator, the pressure chamber vibrates by an action of the actuator, a volume in the pressure chamber changes, and then, the ink drops are discharged from the nozzles communicating with the pressure chamber.

Incidentally, the vibration generated in the pressure chamber remains even after the ink drops are discharged. This remaining vibration interferes with the stable discharge of the subsequent ink drops. Therefore, a technology is known, in which the remaining vibration generated in the pressure chamber is suppressed by outputting a pulse signal for suppressing the vibration generated in the pressure chamber, so-called a damping pulse, after a pulse signal for discharging the ink drops as the drive pulse signal, a so-called discharge pulse.

In the related art, an electric potential of the damping pulse is the same as the electric potential of the discharge pulse. For this reason, the same electric field is applied to the actuator not only during the time for discharging of the ink drops, that is, during the time for applying the discharge pulse but also during the time regardless of the discharging of the ink drops, that is, during the time for applying the damping pulse. Therefore, there has been a concern of excessive power consumption.

An example of related art includes JP-A-2000-015803.

### DESCRIPTION OF THE DRAWINGS

FIG. 1 is an exploded perspective view illustrating a part of an inkjet head.

FIG. 2 is a lateral cross-sectional view of the front part of the inkjet head.

FIG. 3 is a vertical cross-sectional view of the front part of the inkjet head.

FIG. 4A is a diagram explaining an operation principle of the inkjet head.

FIG. 4B is a diagram explaining an operation principle of the inkjet head.

FIG. 4C is a diagram explaining an operation principle of the inkjet head.

FIG. 5 is a block diagram illustrating a hardware configuration of the inkjet printer.

FIG. 6 is a block diagram illustrating a specific configuration of a head drive circuit in the inkjet printer.

FIG. 7 is a schematic circuit diagram of a buffer circuit and a switching circuit included in the head drive circuit.

FIG. 8 is a waveform diagram illustrating an example of a drive pulse signal in the related art supplied to a channel group from the head drive circuit.

FIG. 9 is a diagram illustrating a change of the electric field generated in each actuator and a change of a pressure in a pressure chamber when the drive pulse signal is supplied to each channel.

FIG. 10 is a waveform diagram illustrating an example of the drive pulse signal in the present embodiment supplied to the channel group from the head drive circuit.

FIG. 11 is a diagram illustrating a change of the electric field generated in the actuator and a change of the pressure in the pressure chamber when the drive pulse signal is supplied to each channel.

### DETAILED DESCRIPTION

An object of the exemplary embodiment herein is to provide an inkjet head with which the power consumption can be reduced by decreasing an electric field applied to the actuator during the time regardless of the discharging of the ink drops with respect to the time for discharging the ink drops, and to provide an inkjet printer using the head.

In general, according to one embodiment, an inkjet head includes: a pressure chamber which is filled with an ink; a plate having nozzles communicating with the pressure chamber; an actuator that causes ink drops to be discharged from the nozzles communicating with the pressure chamber by changing a volume in the pressure chamber; and a drive circuit that outputs a drive pulse signal including an expansion pulse which expands the volume of the pressure chamber and a shrinking pulse which shrinks the volume of the pressure chamber to the actuator such that the drive pulse signal is output, in which an electric field applied to the actuator during the time for not discharging the ink drops is lower than an electric field applied to the actuator during the time for discharging the ink drops.

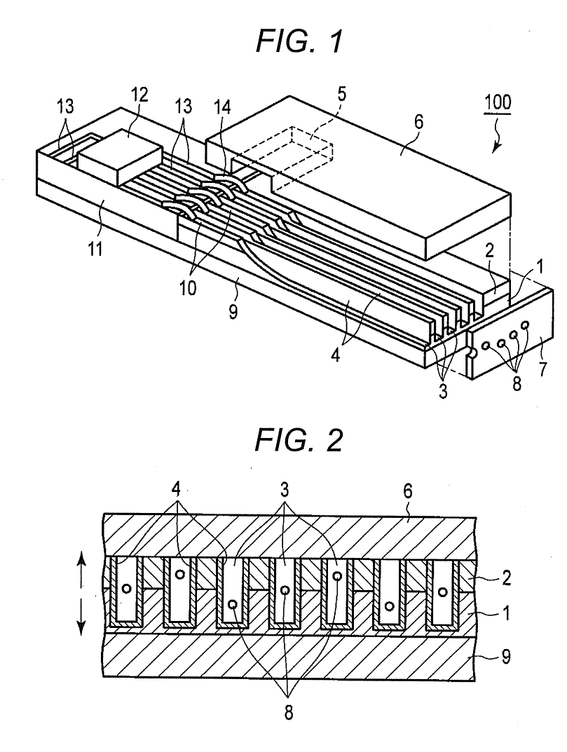

Hereinafter, an inkjet head in the embodiment and an inkjet printer using the head will be described using the drawings. Incidentally, in this embodiment, a share mode type inkjet head 100 (refer to FIG. 1) is exemplified as an inkjet head.

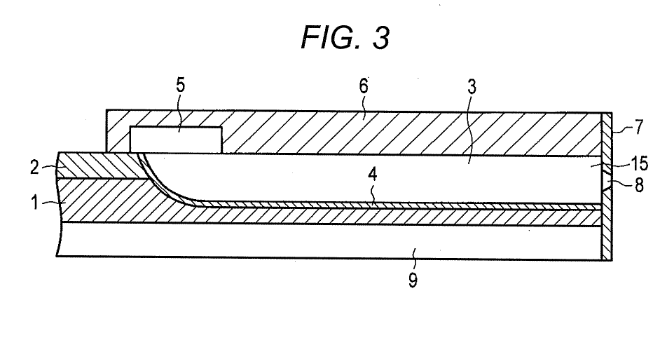

Firstly, a configuration of the inkjet head 100 (hereinafter, referred to as a head 100) will be described using FIG. 1 to FIG. 3. FIG. 1 is a perspective view explosively illustrating a part of a head 100, FIG. 2 is a lateral cross-sectional view of the front part of the head 100, and FIG. 3 is a vertical cross-sectional view in the front part of the head 100.

The head 100 includes a base substrate 9. In the head 100, a first piezoelectric member 1 is joined to the front side upper surface of the base substrate 9 and a second piezoelectric member 2 is joined to the first piezoelectric member 1. The joined first piezoelectric member land the second piezoelectric member 2 are polarized in an opposite direction to each other along the thickness direction of the substrate as illustrated by arrows in FIG. 2.

The base substrate 9 is formed using a material having a small dielectric constant and of which the difference in thermal expansion coefficient between the first piezoelectric member 1 and the second piezoelectric member 2 is small. As the material for the base substrate 9, for example, aluminum oxide (Al₂O₃), silicon nitride (Si₃N₄), silicon carbide (SiC), Aluminum nitride (AlN), lead zirconate titanate (PZT), or the like may be used. On the other hand, as the material for the first piezoelectric member 1 and the second piezoelectric member 2, lead zirconate titanate (PZT), lithium niobate (LiNbO₃), lithium tantalate (LiTaO₃), or the like may be used.

In the head 100, a plurality of long grooves 3 is provided in a direction toward the rear end side of the first piezoelectric member 1 and the second piezoelectric member 2 joined to each other from the front end side thereof. The interval between each groove 3 is constant and is parallel to each other. The front end of the groove 3 is open and the rear end thereof is inclined upward.

In the head 100, electrodes 4 are provided on side walls and the lower surface of each groove 3. The electrode 4 has a two-layer structure of nickel (Ni) and gold (Au). The electrode 4 is uniformly deposited in each groove 3 by, for example, a plating method. The method of forming the electrode 4 is not limited to a plating method. As other methods, a sputtering method or an evaporation method can also be used.

In the head 100, an extraction electrode 10 is provided to extend in a direction toward the rear part upper surface of the second piezoelectric member 2 from the rear end of each groove 3. The extraction electrode 10 extends from the electrode 4.

The head 100 includes a top plate 6 and an orifice plate 7. The top plate 6 closes the upper part of each groove 3. The orifice plate 7 closes the front end of each groove 3. In the head 100, a plurality of pressure chambers 15 is formed by each groove 3 surrounded by the top plate 6 and the orifice plate 7. The pressure chamber 15 has a shape of, for example, 300 μm in depth and 80 μm in width. The pressure chambers are arrayed in parallel with a pitch of 169 μm. The pressure chamber 15 like this is also referred to as an ink chamber.

The top plate 6 includes a common ink chamber 5 in side of the rear part thereof. In the orifice plate 7, nozzles 8 are provided at the position facing the groove 3. The nozzles 8 communicate with the facing groove 3, that is, the pressure chamber 15. The nozzles 8 have a tapered shape toward the ink discharging side opposite to the pressure chamber 15 side. The nozzles 8 are formed at a constant interval in a height direction (vertical direction on the paper in FIG. 2) of the groove 3 with the nozzles corresponding to three adjacent pressure chambers 15 as one set.

In the head 100, a printed circuit board 11 on which a conductive pattern 13 is formed is joined to the rear side upper surface of the base substrate 9. Then, in the head 100, a drive IC 12 on which a below-described head drive circuit 101 is embedded is mounted on the printed circuit board 11. The drive IC 12 is connected to the conductive pattern 13. The conductive pattern 13 is coupled to lead wires 14 through a wire bonding to the extraction electrode 10.

A group of the pressure chambers 15, the electrode 4, and the nozzles 8 that are included in the head 100 is called channel. That is, the head 100 has N channels: ch. 1, ch. 2, . . . , ch. N which is the number of grooves 3.

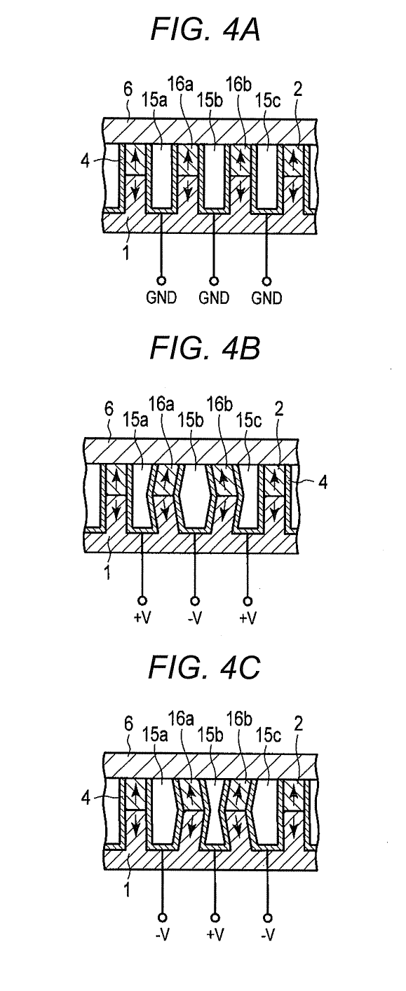

Next, an operation principle of the head 100 configured as described above will be described using FIG. 4A to FIG. 4C.

FIG. 4A illustrates a state in which any of the electric potentials of the electrodes 4 arrayed on each wall surfaces of the center pressure chamber 15b and both of the pressure chambers 15a and 15c adjacent to the center pressure chamber 15b are the ground potential GND. In this state, both of a partition wall 16a interposed between the pressure chamber 15a and the pressure chamber 15b and a partition wall 16b interposed between the pressure chamber 15b and the pressure chamber 15c do not receive any distortion effect.

FIG. 4B illustrates a state in which a negative voltage −V is applied to the electrode 4 of the center pressure chamber 15b and a positive voltage +V is applied to the electrode 4 of both side pressure chambers 15a and 15c. In this state, with respect to each partition wall 16a and 16b, the electric field of twice the voltage V acts toward the direction orthogonal to the polarization direction of the piezoelectric members 1 and 2. With this action, each partition wall 16a and 16b respectively deforms outward such that the volume of the pressure chamber 15b expands.

FIG. 4C illustrates a state in which a positive voltage +V is applied to the electrode 4 of the center pressure chamber 15b and a negative voltage −V is applied to the electrode 4 of both side pressure chambers 15a and 15c. In this state, with respect to each partition wall 16a and 16b, the electric field twice the voltage V acts toward the opposite to the direction of the case in FIG. 4B. With this action, each partition wall 16a and 16b respectively deforms inward such that the volume of the pressure chamber 15b shrinks.

If the volume of the pressure chamber 15b expands or shrinks, a pressure vibration occurs in the pressure chamber 15b. The pressure in the pressure chamber 15b increases due to this pressure vibration, and thus, the ink is discharged from the nozzles 8 communicating with the pressure chamber 15b.

As described above, the partition walls 16a and 16b that separate each pressure chamber 15a, 15b, and 15c are the actuators for applying the pressure vibration in the pressure chamber 15b having the partition walls 16a and 16b as wall surfaces. That is, each pressure chamber 15 shares actuators with the adjacent pressure chambers 15. For this reason, the head drive circuit 101 cannot individually drive each pressure chamber 15. The head drive circuit 101 drives each pressure chamber 15 by dividing the chambers into (n+1) groups for every n chambers (n is an integer equal to or greater than two). The present embodiment illustrates a case where the head drive circuit 101 drives pressure chambers 15 by dividing the chambers into three groups for every two chambers, a so called case of three-division driving. The three-division driving is just an example, and four-division driving or five-division driving may be used.

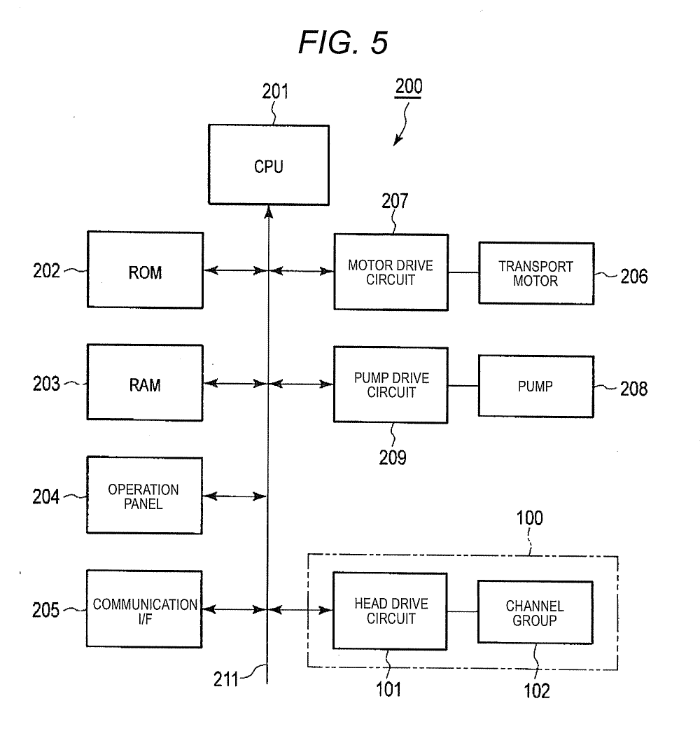

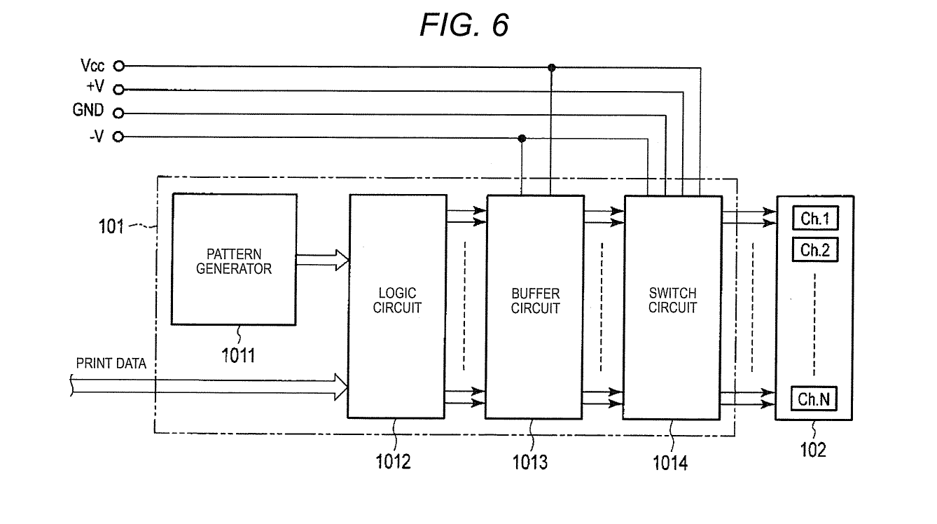

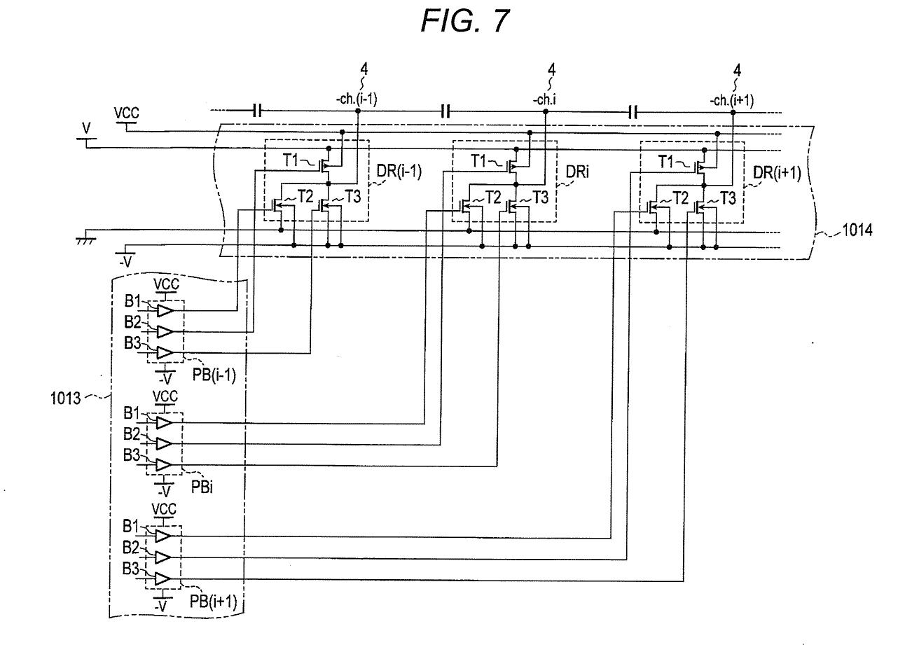

Next, a configuration of an inkjet printer 200 (hereinafter, simply referred to as printer 200) will be described using FIG. 5 to FIG. 7. FIG. 5 is a block diagram illustrating a hardware configuration of the printer 200. FIG. 6 is a block diagram illustrating a specific configuration of a head drive circuit 101. FIG. 7 is a schematic circuit diagram of a buffer circuit 1013 and a switching circuit 1014 included in the head drive circuit 101.

The printer 200 includes a central processing unit (CPU) 201, a read only memory (ROM) 202, a random access memory (RAM) 203, an operation panel 204, a communication interface 205, a transport motor 206, a motor drive circuit 207, a pump 208, a pump drive circuit 209, and the head 100. In addition, the printer 200 includes a bus line 211 such as an address bus or a data bus. The printer 200 connects each of the CPU 201, the ROM 202, the RAM 203, the operation panel 204, the communication interface 205, the motor drive circuit 207, a pump drive circuit 209, and the drive circuit 101 of the head 100 to the bus line 211 directly or via an input-output circuit.

The CPU 201 corresponds to a central portion of the computer. The CPU 201 controls each member that realizes each function as the printer 200 according to the operating system or an application program.

The ROM 202 corresponds to a main memory portion of the computer. The ROM 202 stores the operating system and an application program. In some cases, the ROM 202 stores data necessary for the CPU 201 to execute the processing of controlling each member.

The RAM 203 corresponds to a main memory portion of the computer. The RAM 203 stores data necessary for the CPU 201 to execute processing. The RAM 203 is also used as a work area in which the information is appropriately rewritten by the CPU 201. The work area includes an image memory in which the print data is deployed.

The operation panel 204 includes an operation unit and a display unit. On the operation unit, function keys such as a power key, a sheet feeding key, and an error release key are disposed. On the display unit, various states of the printer 200 can be displayed.

The communication interface 205 receives the print data from a client terminal connected via a network such as a local area network (LAN). For example, when an error occurs in the printer 200, the communication interface 205 transmits a signal notifying the client terminal of the error.

The motor drive circuit 207 controls the driving of the transport motor 206. The transport motor 206 functions as a drive source of a transport mechanism for transporting a recording medium such as printing paper. When the transport motor 206 is driven, the transport mechanism starts the transportation of the recording medium. The transport mechanism transports the recording medium to the position of printing by the head 100. The transport mechanism discharges the printed recording medium to the outside of the printer 200 from a discharge port (not illustrated).

The pump drive circuit 209 controls the driving of the pump 208. When the pump 208 is driven, the ink in an ink tank (not illustrated) is supplied to the head 100.

The head drive circuit 101 drives the channel group 102 of the head 100 based on the print data. As illustrated in FIG. 6, the head drive circuit 101 includes a pattern generator 1011, a logic circuit 1012, a buffer circuit 1013, and a switching circuit 1014.

The pattern generator 1011 generates waveform patterns such as a discharging waveform, discharging waveform of both sides, non-discharging waveform, and a non-discharging waveform of both sides. The data of the waveform patterns generated in the pattern generator 1011 is supplied to the logic circuit 1012.

The logic circuit 1012 receives the input print data read one line at a time from the image memory. When the print data is input, the logic circuit 1012 determines whether the center channel ch. i is a discharge channel from which the ink is discharged or a non-discharge channel from which the ink is not discharged with the adjacent three channels ch. (i−1), ch. i, and ch. (i+1) of the head 100 as one set. Then, if the channel ch. i is a discharge channel, the logic circuit 1012 outputs the pattern data of the discharging waveform with respect to the channel ch. i, and outputs the pattern data of the discharging waveform of both sides with respect to the adjacent channels ch. (i−1) and ch (i+1). If the channel ch. i is anon-discharging channel, the logic circuit 1012 outputs the pattern data of the non-discharging waveform with respect to the channel ch. i, and outputs the pattern data of the non-discharging waveform of both sides with respect to the adjacent channels ch. (i−1) and ch. (i+1). Each piece of pattern data output from the logic circuit 1012 is supplied to the buffer circuit 1013.

The buffer circuit 1013 connects the power source of positive voltage Vcc and the power source of negative voltage −V. In addition, as illustrated in FIG. 7, the buffer circuit 1013 includes pre-buffers PB1, PB2, . . . , PBN for each of the channels ch. 1, ch. 2, . . . , ch. N of the head 100. In FIG. 7, the pre-buffers PB (i−1), PBi, and PB (i+1) corresponding to each of the adjacent three channels ch. (i−1), ch. i, and ch. (i+1) are illustrated.

Each of the pre-buffers PB1, PB2, . . . , PBN respectively includes three buffers of a first buffer B1, a second buffer B2, and a third buffer B3. Each buffer B1, B2, B3 is respectively connected to the power source of positive voltage Vcc and the power source of negative voltage −V.

In each of the pre-buffers PB1, PB2, . . . , PBN, the outputs of the first to third buffers B1, B2, and B3 change according to the level of the signals supplied from the logic circuit 1012. The signal having a different level according to whether the corresponding channel ch. k (1≦k≦N) is a discharging channel, a non-discharging channel, or a channel adjacent to a discharging channel or a non-discharging channel, is supplied from the logic circuit 1012. The first to third buffers B1, B2, and B3 to which a high level signal is supplied outputs a signal having a positive voltage Vcc level. The first to third buffers B1, B2, and B3 to which a low level signal is supplied outputs a signal having a negative voltage −V level.

The outputs of each of the pre-buffers PB1, PB2, and PB3, that is, the output signals of the first to third buffers B1, B2, and B3 are supplied to the switching circuit 1014.

The switching circuit 1014 connects the power source of the positive voltage Vcc, the power source of the positive voltage +V, the power source of the negative voltage −V, and the ground potential GND. The positive voltage Vcc is higher than the positive voltage +V. As the representative value thereof: the positive voltage Vcc is 24 volts and the positive voltage +V is 15 volts. In this case, the negative voltage −V is −15 volts.

As illustrated in FIG. 7, the switching circuit 1014 includes drivers DR1, DR2, . . . , DRN for each of the channels ch. 1, ch. 2, . . . , ch. N of the head 100. In FIG. 7, the drivers DR(i−1), DRi, and DR(i+1) corresponding to each of the adjacent three channels ch.(i−1), ch. i, and ch. (i+1) are illustrated.

Each of the drivers DR1, DR2, . . . , DRN respectively includes a PMOS type field effect transistor T1 (hereinafter, referred to as a first transistor T1) and two NMOS type field effect transistors T2 and T3 (hereinafter, referred to as a second transistor T2 and a third transistor T3). Each of the drivers DR1, DR2, . . . , DRN respectively connects a series circuit of the first transistor T1 and the second transistor T2 to a point between the power source of the positive voltage V and the ground potential GND, and further connects the third transistor T3 to the connection point between the first transistor T1 and the second transistor T2 and the power source of the negative voltage −V. In addition, each of the drivers DR1, DR2, . . . , DRN respectively connects the back gate of the first transistor T1 to the power source of the positive voltage Vcc, and respectively connects the back gates of the second transistor and the third transistor to the power source of negative voltage −V. Furthermore, the drivers DR1, DR2, . . . , DRN connect the first buffer B1 of the respectively corresponding pre-buffers PB1, PB2, . . . , PBN to the gate of the second transistor T2, connect the second buffer B2 to the gate of the first transistor T1, and connect the third buffer B3 to the gate of the third transistor T3. Then, each of the drivers DR1, DR2, . . . , DRN respectively applies the potential at the connection point between the first transistor T1 and the second transistor T2 to the electrode 4 of corresponding channels ch. 1, ch. 2, . . . , ch. N.

Therefore, the first transistor T1 is in an OFF state when the signal having the level of positive voltage Vcc is input from the second buffer B2, and is in an ON state when the signal having the level of negative voltage −V is input. The second transistor T2 is in an ON state when the signal having the level of the positive voltage Vcc is input from the first buffer B1 and is in an OFF state when the signal having the level of the negative voltage −V is input. The third transistor T3 is in an ON state when the signal having level of the positive voltage Vcc is input from the third buffer B3, and is in an OFF state when the signal having the level of the negative voltage −V is input.

The drivers DR1, DR2, . . . , DRN having the configuration described above apply the positive voltage V to the electrode 4 of the corresponding channels ch. 1, ch. 2, . . . , ch. N when the first transistor T1 is in an ON state and the second transistor T2 and the third transistor T3 are in an OFF state. When the first transistor T1 and the third transistor T3 are in an OFF state simultaneously and the second transistor T2 is in an ON state, the drivers DR1, DR2, . . . , DRN make the electric potential of the electrode 4 of the corresponding channels ch. 1, ch. 2, . . . , ch. N be at the level of ground potential GND. When the first transistor T1 and the second transistor T2 are in an OFF state simultaneously and the third transistor T3 is in an ON state, the negative voltage −V is applied to the electrode 4 of the corresponding channels ch. 1, ch. 2, . . . , ch. N.

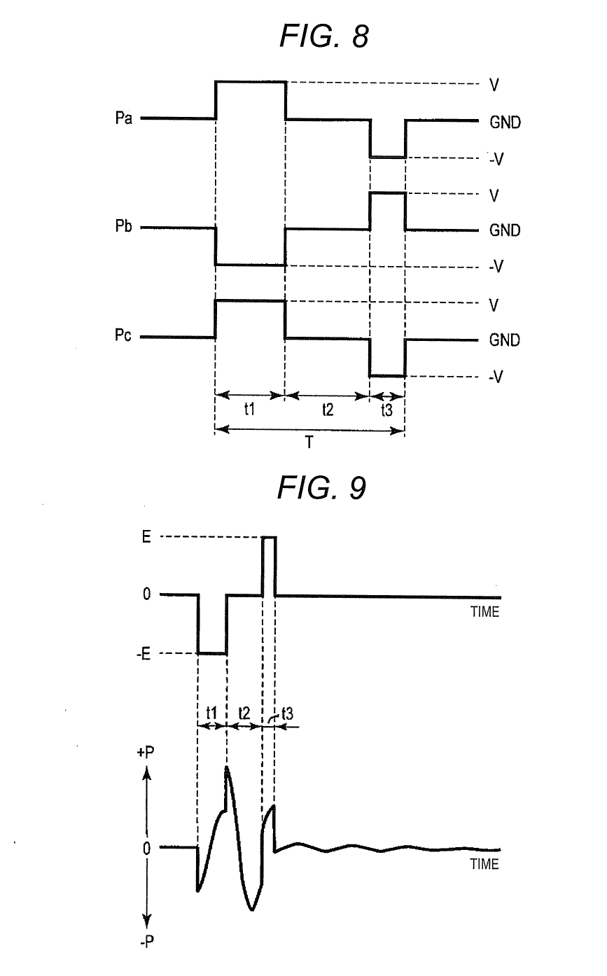

Next, the drive pulse signal which is supplied to the channel group 102 from the head drive circuit 101 will be described. Firstly, the drive pulse signal in the related art will be described using FIG. 8 and FIG. 9.

In FIG. 8, drive pulse signals Pa, Pb, and Pc supplied to each channel ch. a, ch. b, and ch. c if one drop of ink is discharged from the center channel ch. b among the adjacent three channels ch. a, ch. b, and ch c, are illustrated. That is, the drive pulse signal Pb is a signal according to the pattern data of the first discharging waveform generated in the pattern generator 1011. Other drive pulse signals Pa and Pc are signals according to the pattern data of the first discharging waveform of both sides generated in the pattern generator 1011.

A time T is a time required for discharging one drop of ink. In this time T, firstly, the head drive circuit 101 outputs the drive pulse signals Pa, Pb, and Pc such that the negative voltage −V is applied to the center channel ch. b and the positive voltage +V is applied to the channels ch. a and ch. c of both sides during a first time t1. As illustrated in FIG. 4B, by these drive pulse signals Pa, Pb, and Pc, the pressure chamber 15b corresponding to the channel ch. b is expanded, and thus, the ink is supplied to the pressure chamber 15b.

Subsequently, the headdrive circuit 101 outputs the drive pulse signals Pa, Pb, and Pc such that the voltage supplied to each channel ch. a, ch. b and ch. c returns to the ground potential GND during a second time t2. As illustrated in FIG. 4A, due to these drive pulse signals Pa, Pb, and Pc, the volume of the pressure chamber 15b corresponding to the channel ch. b returns to the normal state. Due to this change of the volume, the pressure in the pressure chamber 15b increases, and thus, ink drops are discharged from the nozzles 8 that are communicated with the pressure chamber 15b.

Subsequently, the head drive circuit 101 outputs the drive pulse signals Pa, Pb, and Pc such that the positive voltage +V is applied to the center channel ch. b and the negative voltage −V is applied to the channels ch. a and ch. c of both sides during a third time t3. As illustrated in FIG. 4C, due to these drive pulse signals Pa, Pb, and Pc, the pressure chamber 15b corresponding to the channel ch. b shrinks. By this change of the volume, the pressure vibration after the discharge of the ink in the pressure chamber 15b is suppressed.

Then, the head drive circuit 101 outputs the drive pulse signals Pa, Pb, and Pc such that the voltages applied to the channels ch. a, ch. b, and ch. c return to the ground potential GND. As illustrated in FIG. 4A, due to these drive pulse signals Pa, Pb, and Pc, the volume of the pressure chamber 15b corresponding to the channel ch. b returns to the normal state.

FIG. 9 illustrates the change of the pressure in the pressure chamber 15 and the changes of the electric field occurring in the actuator which is one of the partition walls 16b when the drive pulse signals Pa, Pb, and Pc illustrated in FIG. 8 are applied to each of the channels ch. a, ch. b. and ch. c. Incidentally, the direction of the electric field generated in the actuator which is another partition wall 16a and the direction of the electric field generated in the actuator which is the partition wall 16b are inverted with respect to each other.

As illustrated in FIG. 9, in a case of the drive pulse signals Pa, Pb, and Pc, when the electric field generated in the actuator during the first time t1, that is, generated by a so-called discharge pulse is assumed to be “−E”, the electric field generated in the actuator during the third time t3, that is, generated by a so-called damping pulse is “E”.

On the other hand, the pressure in the pressure chamber 15b rapidly increases at the ending time of the discharge pulse. Due to this change of the pressure, ink drops are discharged from the nozzles 8 which is communicating with pressure chamber 15b. After the ink drops are discharged, the pressure in the pressure chamber 15b decreases to a negative pressure as the second time t2 elapses, and again increases to a positive pressure due to inputting the damping pulse. Then, the pressure returns to substantially zero due to the ending of the damping pulse. That is, the remaining vibration generated in the pressure chamber 15 is suppressed.

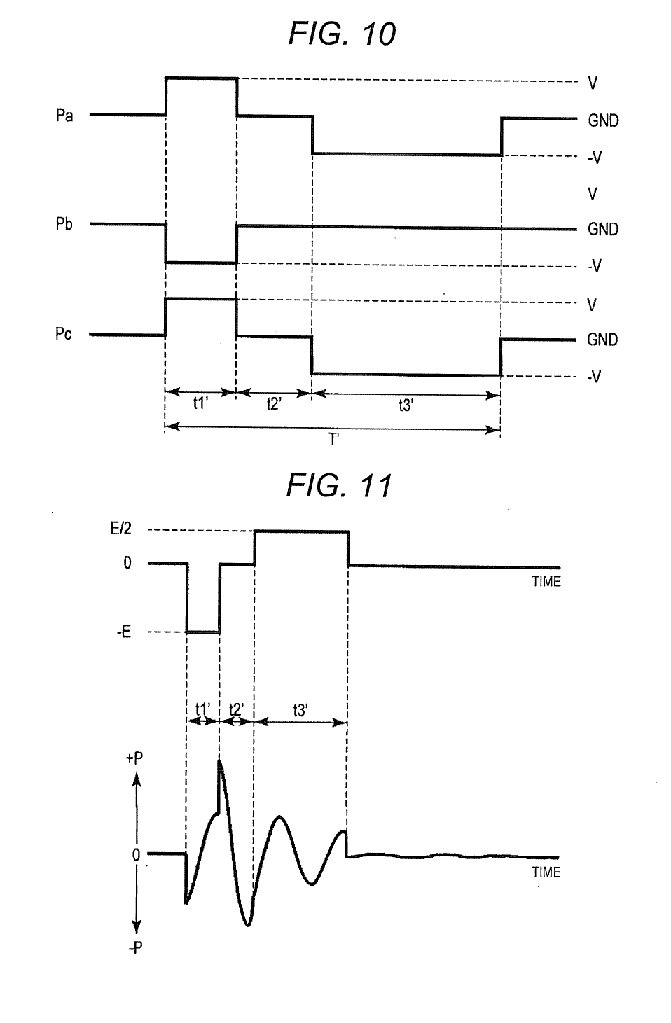

Next, the drive pulse signal in the present embodiment will be described using FIG. 10 and FIG. 11.

FIG. 10 illustrates the drive pulse signals Pa, Pb, and Pc supplied to each channel ch. a, ch. b, and ch. c if one drop of ink is discharged from the center channel ch. b among the three adjacent channels ch. a, ch. b, and ch. c. That is, the drive pulse signal Pb is a signal according to the pattern data of the first discharging waveform generated in the pattern generator 1011. Other drive pulse signals Pa and Pc are signals according to the pattern data of the first discharging waveform of both sides generated in the pattern generator 1011.

A time T′ is a time required for discharging one drop of ink. In this time T′, firstly, the head drive circuit 101 outputs the drive pulse signals Pa, Pb, and Pc such that the negative voltage −V is applied to the center channel ch. b and the positive voltage +V is applied to the channels ch. a and ch. c of both sides during a first time t1′. As illustrated in FIG. 4B, by these drive pulse signals Pa, Pb, and Pc, the pressure chamber 15b corresponding to the channel ch. b is expanded, and thus, the ink is supplied to the pressure chamber 15b. The first time t1′ has the same length as the first time t1 in the example in the related art.

Subsequently, the head drive circuit 101 outputs the drive pulse signals Pa, Pb, and Pc such that the voltage supplied to each channel ch. a, ch. b and ch. c returns to the ground potential GND during a second time t2′ . As illustrated in FIG. 4A, due to these drive pulse signals Pa, Pb, and Pc, the volume of the pressure chamber 15b corresponding to the channel ch. b returns to the normal state. Due to this change of the volume, the pressure in the pressure chamber 15b increases, and thus, ink drops are discharged from the nozzles 8 that are communicating with the pressure chamber 15b. The second time t2′ is shorter than the second time t2 in the example in the related art.

Subsequently, the head drive circuit 101 outputs the drive pulse signals Pa, Pb, and Pc such that the negative voltage −V is applied to the channels ch. a and ch. c of both sides and the ground potential GND is maintained in the center channel ch. b during a third time t3′ . As illustrated in FIG. 4C, due to these drive pulse signals Pa, Pb, and Pc, the pressure chamber 15b corresponding to the channel ch. b shrinks. By this change of the volume, the pressure vibration after the discharge of the ink in the pressure chamber 15b is suppressed. The third time t3′ is longer than the third time t3 in the example in the related art.

Then, the head drive circuit 101 outputs the drive pulse signals Pa, Pb, and Pc such that the voltages applied to the channels ch. a, ch. b, and ch. c return to the ground potential GND. As illustrated in FIG. 4A, due to these drive pulse signals Pa, Pb, and Pc, the volume of the pressure chamber 15b corresponding to the channel ch. b returns to the normal state.

FIG. 11 illustrates the change of pressure in the pressure chamber 15 and the changes of the electric field occurring in the actuator which is one of the partition walls 16b when the drive pulse signals Pa, Pb, and Pc illustrated in FIG. 10 are applied to each of the channels ch. a, ch. b. and ch. c. Incidentally, the direction of the electric field generated in the actuator which is another partition wall 16a and the direction of the electric field generated in the actuator which is the partition wall 16b are inverted with respect to each other.

As illustrated in FIG. 11, in a case of the drive pulse signals Pa, Pb, and Pc, when the electric field generated in the actuator during the first time t1′ that is, generated by the so-called discharge pulse is assumed to be “−E”, the electric field generated in the actuator during the third time t3′ , that is, generated by the so-called damping pulse is “E/2”.

On the other hand, the pressure in the pressure chamber 15b rapidly increases at the ending time of the discharge pulse. By this change of the pressure, the drops are discharged from the nozzles 8 communicating with pressure chamber 15b. After the ink drops are discharged, the pressure in the pressure chamber 15b decreases to a negative pressure as the second time t2′ elapses, and again increases to a positive pressure due to inputting the damping pulse. Then, the pressure repeats being inverted between positive and negative during the time when the damping pulse is applied, and returns to substantially zero due to the ending of the damping pulse. That is, the remaining vibration generated in the pressure chamber 15 is suppressed.

In this way, by using the drive pulse signals Pa, Pb, and Pc illustrated in FIG. 10, even when the electric field generated in the actuator by the damping pulse is “E/2”, it is possible to obtain the effect of suppressing the remaining vibration in the pressure chamber 15.

Here, the effect of decreasing the electric field generated in the actuator by the damping pulse from “E” to “E/2” will be verified. In performing the verification, in the drive pulse signals Pa, Pb, and Pc in the related art illustrated in FIG. 8, the first time t1 is set to be 1.6 μsec, the second time t2 is set to be 2.00 μsec, and the third time t3 is set to be 0.73 μsec. In addition, the drive power source V is set to be 15 V and −15 V, and the number of drive nozzles is set to be 200. On the other hand, in the drive pulse signals Pa, Pb, and Pc in the present embodiment illustrated in FIG. 10, the first time t1′ is set to be 1.6 μsec, the second time t2′ is set to be 1.70 μsec, and the third time t3′ is set to be 4.60 μsec. The drive power source V and the number of drive nozzles are set to be the same as that in the related art. The current flowing from the drive power source V to the +V power source terminal of the head 100 is set as a positive side drive source current, and the current flowing from the −V power source terminal of the head 100 to the drive power source −V is set as a negative side drive source current.

In the case of the examples in the related art, an average current of the positive side drive source current within a time sufficient for outputting the drive pulse signals Pa, Pb, and Pc is 535 mA and an average current of the negative side drive source is 612 mA. In contrast, in the present embodiment, an average current of the positive side drive source current within a time sufficient for outputting the drive pulse signals Pa, Pb, and Pc is 270 mA and an average current of the negative side drive source is 488 mA.

In this way, when the electric field of the damping pulse is “E/2”, the voltage to be charged in the electrostatic capacitor becomes half compared to the case where the electric field of the damping pulse is “E”. Therefore, it is possible to reduce the charging current. In addition, the width of the damping pulse is widened, but there is no disadvantage in driving the capacitive load. Therefore, it is very effective in the inkjet printer having an object of reducing the power consumption rather than high-speed operation.

In the embodiment described above, when the electric field applied to the actuator during the time for discharging ink drops is set to be “E”, the drive pulse signal in which the electric field applied to the actuator during the time for not discharging ink drops is “E/2” is output to the actuator. However, the electric field applied to the actuator during the time for not discharging ink drops is not limited to being “E/2”. As long as the electric field is lower than “E”, it can be applied because the effect of reducing the power consumption can be achieved.

In addition, some embodiments are described, however, these embodiments are just examples and are not intended to limit the scope of the exemplary embodiments. New embodiments can be executed in various other forms, and various omissions, replacements, or changes can be performed without departing from the spirit of the exemplary embodiments. These embodiments and modification thereof will be included in the scope or spirit of the exemplary embodiments, and included in the scope equivalent as set forth in the aspects of the exemplary embodiments.

What is claimed is:

1. An inkjet head comprising:
a pressure chamber which is filled with an ink;
a plate having nozzles communicating with the pressure chamber;
an actuator that causes ink drops to be discharged from the nozzles communicating with the pressure chamber by changing a volume in the pressure chamber; and
a drive circuit that outputs a drive pulse signal including an expansion pulse which expands the volume of the pressure chamber and a shrinking pulse which shrinks the volume of the pressure chamber to the actuator such that the drive pulse signal is output, in which an electric field applied to the actuator during the time for not discharging the ink drops is lower than an electric field applied to the actuator during the time for discharging the ink drops.

2. The inkjet head according to claim 1,
wherein the time for discharging the ink drops is a pulse width time of the expansion pulse that causes the ink drops to be discharged from the nozzles by returning the volume of the pressure chamber to the normal state after expanding the volume of the pressure chamber.

3. The inkjet head according to claim 1,
wherein the time for not discharging the ink drops is a pulse width time of the shrinking pulse that suppresses a remaining vibration generated in the pressure chamber by returning the volume of the pressure chamber to the normal state after shrinking the volume of the pressure chamber.

4. The inkjet head according to claim 1,
wherein, when the electric field applied to the actuator during the time for discharging the ink drops is set to be “E”, the drive circuit outputs the drive pulse signal in which the electric field applied to the actuator during the time for not discharging the ink drops is “E/2” to the actuator.

5. An inkjet printer comprising:
the inkjet head according to claim 1; and
a pump that supplies the ink in an ink tank to the inkjet head.

6. An inkjet printer comprising:
the inkjet head according to claim 2; and
a pump that supplies the ink in an ink tank to the inkjet head.

7. An inkjet printer comprising:
the inkjet head according to claim 3; and
a pump that supplies the ink in an ink tank to the inkjet head.

8. An inkjet printer comprising:
the inkjet head according to claim 4; and
a pump that supplies the ink in an ink tank to the inkjet head.
